(19) United States
(12) Patent Application Publication
(10) Pub. No.: US 2019/0311265 A1
(43) Pub. Date: Oct. 10, 2019

(54) METHOD AND DEVICE FOR OBTAINING A SYSTEM FOR LABELLING IMAGES

(71) Applicant: COMMISSARIAT A L'ENERGIE ATOMIQUE ET AUX ENERGIES ALTERNATIVES, Paris (FR)

(72) Inventors: Youssef TAMAAZOUSTI, Palaiseau (FR); Herve LE BORGNE, Palaiseau (FR); Celine HUDELOT, Bourg la Reine (FR)

(73) Assignee: COMMISSARIAT A L'ENERGIE ATOMIQUE ET AUX ENERGIES ALTERNATIVES, Paris (FR)

(21) Appl. No.: 16/466,889

(22) PCT Filed: Dec. 1, 2017
(86) PCT No.: PCT/FR2017/053342

§ 371 Date: Jun. 5, 2019

(30) Foreign Application Priority Data
Dec. 6, 2016 (FR) 1662013

(51) Int. Cl. G06N 3/08; G06N 3/04; G06N 20/00

(52) U.S. Cl. CPC G06N 3/08; G06N 20/00; G06N 3/0454

(57) ABSTRACT

This method comprises: obtaining a first module for labelling images by machine learning on the basis of a first training corpus; obtaining a second training corpus from the first training corpus, by replacing, in the first training corpus, each of a portion of first labels by a replacement label, two first labels being replaced by one and the same replacement label; obtaining a second module for labelling images by machine learning on the basis of the second training corpus; obtaining the system for labelling images comprising: a first upstream module obtained from a portion of the first module, a second upstream module obtained from a portion of the second module and a downstream module designed to provide a labelling of an image on the basis of first descriptive data provided by the first upstream module and of second descriptive data provided by the second upstream module.

The present invention relates to a method for obtaining a program for labelling images, a corresponding computer program and device and a system for labelling images.

The invention applies more particularly to a method for obtaining a system for labelling images, comprising:
obtaining a first module for labelling images that has been trained by machine learning on a computer on the basis of a first training corpus comprising first images associated with first labels, in such a way that, when the first module receives, as an input, one of the first images, the first module provides an output consistent with the first label associated with this first image in the first training corpus,
obtaining the system for labelling images in such a way that it comprises:
   a first upstream module designed to receive an image to be labelled and to provide first descriptive data of the image to be labelled, the first upstream module being obtained from at least a portion of the first module,
   a downstream module designed to provide a labelling of the image to be labelled on the basis of the first descriptive data.

For example, the first article “From generic to specific deep representations for visual recognition” by H. Azizpour, A. Razavian, J. Sullivan, A. Maki and S. Carlsson, published in 2015 in Computer Vision and Pattern Recognition Workshops, (CVPRW), describes a transfer-learning method. More precisely, this article proposes training the convolutional neural network AlexNet on the basis of a first training corpus in order to obtain a first module for labelling images. This article further proposes using the output of the first completely connected neural layer, which is the sixth layer of the network, as data descriptive of an image.

Indeed, this particular layer represents, according to the article, a good compromise when the final task is not known. The descriptive data is thus provided as the input of a downstream module in order to carry out its machine learning in order for the system to be able to label images on the basis of labels that can be different than those of the first training corpus.

In a second article “Factors of transferability for a generic convnet representation” by H. Azizpour, A. Razavian, J. Sullivan, A. Maki, and S. Carlsson, published in 2015 in IEEE Transaction on Pattern Analysis and Machine Intelligence (PAMI), pages 1790-1802, the authors study the influence of the number of labels of the first training corpus on the performance of the system for labelling images. For this, they remove certain classes and the corresponding images (or random images).

It may thus be desired to provide a method for obtaining a program for labelling images that allows to improve the labelling performance of the system for labelling images.

A method for obtaining a system for image labelling is therefore proposed, comprising:
obtaining a first module for labelling images that has been trained by machine learning on a computer on the basis of a first training corpus comprising first images associated with first labels, in such a way that, when the first module receives, as an input, one of the first images, the first module provides an output consistent with the first label associated with this first image in the first training corpus,
obtaining the system for labelling images in such a way that it comprises:
   a first upstream module designed to receive an image to be labelled and to provide first descriptive data of the image to be labelled, the first upstream module being obtained from at least a portion of the first module,
   a downstream module designed to provide a labelling of the image to be labelled on the basis of the first descriptive data.
      the method further comprising:
obtaining a second training corpus comprising the first images associated with second labels by replacing, in the first training corpus, each of at least a portion of the first labels by a replacement label, at least two first labels being replaced by the same replacement label, the second labels comprising the replacement labels and the possible first labels that have not been replaced,
the machine learning, on a computer, of a second module for labelling images on the basis of the second training corpus, in such a way that, when the second module receives, as an input, one of the first images, the second module provides an output consistent with the second label associated with this first image in the second training corpus,
   wherein the system for labelling images further comprises a second upstream module designed to receive the image to be labelled and to provide second descriptive data of the image to be labelled, the second upstream module being obtained from at least a portion of the second module,
   and wherein the downstream module is designed to provide a labelling of the image to be labelled on the basis of the first descriptive data and the second descriptive data.

Thanks to the invention, the first images are labelled in the second training corpus using second labels more generic than the first labels, since images that were earlier associated with different first labels are, in the second training corpus, associated with the same second label. Thus, the first descriptive data provides a more generic representation of the image to be labelled than the second descriptive data. Surprisingly, it is in combining the first “specific” descriptive data and the second “generic” descriptive data at the input of the downstream module that a high-performance system for labelling images can be obtained.

Optionally, each of the first module and the second module comprises successive processing layers starting with a first processing layer, the first upstream module comprises one or more successive processing layers of the first module and the second upstream module comprises one or more successive processing layers of the second module.

Also optionally, the processing layer(s) of the first upstream module comprise the first processing layer of the first module and the processing layer(s) of the second upstream module comprise the first processing layer of the second module.

Also optionally, each of the first module and the second module comprises a convolutional neural network comprising, as successive processing layers, convolutional layers and neural layers that follow the convolutional layers.

Also optionally, the first upstream module comprises the convolutional layers and only a portion of the neural layers of the first module and the second upstream module comprises the convolutional layers and only a portion of the neural layers of the second module.

Also optionally, obtaining the second training corpus comprises, for each of at least a portion of the first labels, the determination, in a predefined tree of labels including in particular the first labels, of an ancestor common to this first label and to at least another first label, the common ancestor determined being the replacement label of this first label.

Also optionally, the method further comprises the machine learning, on a computer, of at least a portion of the downstream module on the basis of a third training corpus comprising third images associated with third labels, in such a way that, when the first upstream module and the second upstream module receive, as an input, one of the third images, the downstream module provides an output consistent with the third label associated with this third image in the third training corpus, the first upstream module and the second upstream module remaining unchanged during the learning.

Also optionally, the downstream module comprises, on the one hand, a first block designed to receive, as an input, the first descriptive data and the second descriptive data and to provide, as an output, global descriptive data and, on the other hand, a second block designed to receive, as an input, the global descriptive data and to provide, as an output, a labelling, and the method further comprises:
the machine learning, on a computer, of the first block on the basis of a fourth training corpus comprising the first images associated with pairs of labels, the pair of labels associated with each first image comprising the first label associated with the first image in the first training corpus and the second label associated with the first image in the second training corpus, in such a way that, when the first upstream module and the second upstream module receive, as an input, one of the first images, the first block provides an output consistent with the pair of labels associated with this first image in the fourth training corpus, the first upstream module and the second upstream module remaining unchanged during the learning,
after the machine learning of the first block, the machine learning, on a computer, of the second block on the basis of the third training corpus, in such a way that, when the first upstream stage and the second upstream stage receive, as an input, one of the third images, the downstream module provides an output consistent with the third label associated with this third image in the third training corpus, the first upstream module, the second upstream module and the first block remaining unchanged during the learning.

A computer program that can be downloaded from a communication network and/or is recorded on a medium readable by computer and/or can be executed by a processor, characterised in that it comprises instructions for the execution of the steps of a method according to the invention, when said program is executed on a computer, is also proposed.

A device for obtaining a system for labelling images, designed to implement a method according to the invention, is also proposed.

A system for labelling images obtained by a method according to the invention is also proposed.

The invention will be better understood via the following description, given only as an example and made in reference to the appended drawings in which:

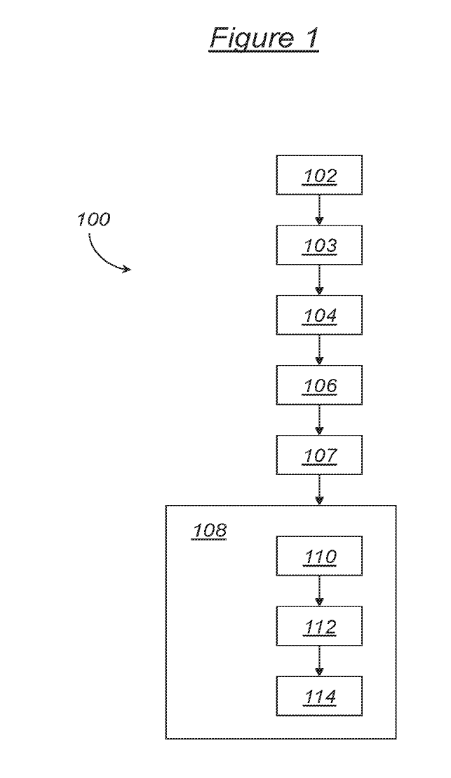

FIG. 1 illustrates the successive steps of a method for obtaining a system for labelling images, according to a first embodiment of the invention,

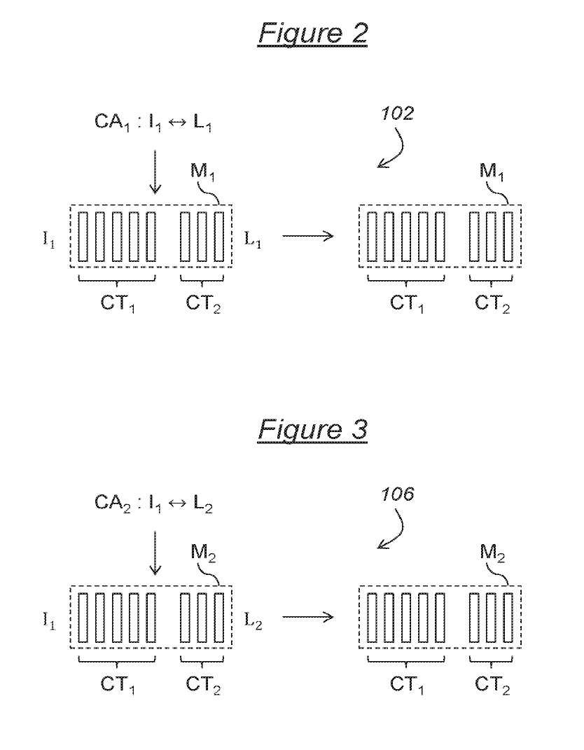

FIGS. 2 to 6 schematically show the operations carried out during steps of the method of FIG. 1,

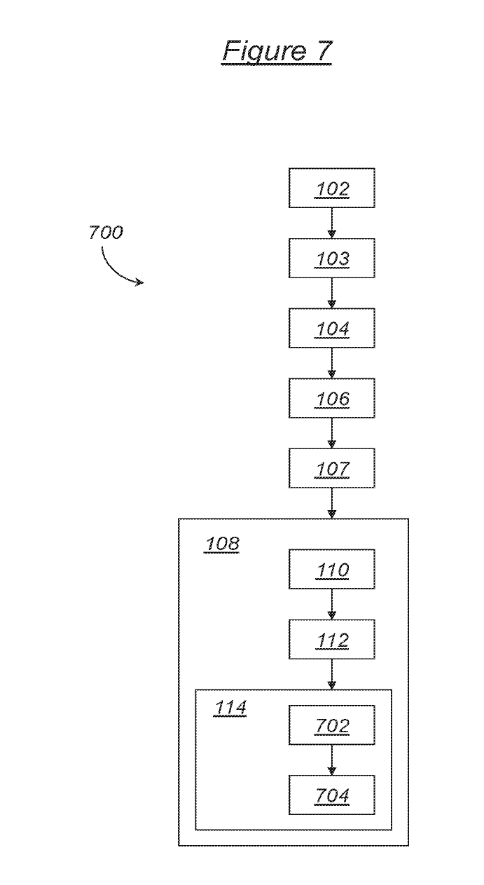

FIG. 7 illustrates the successive steps of a method for obtaining a system for labelling images, according to a second embodiment of the invention,

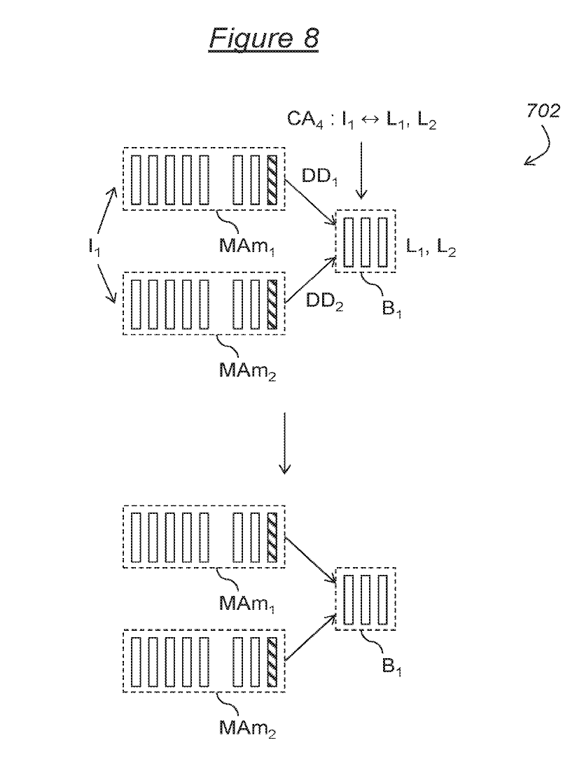

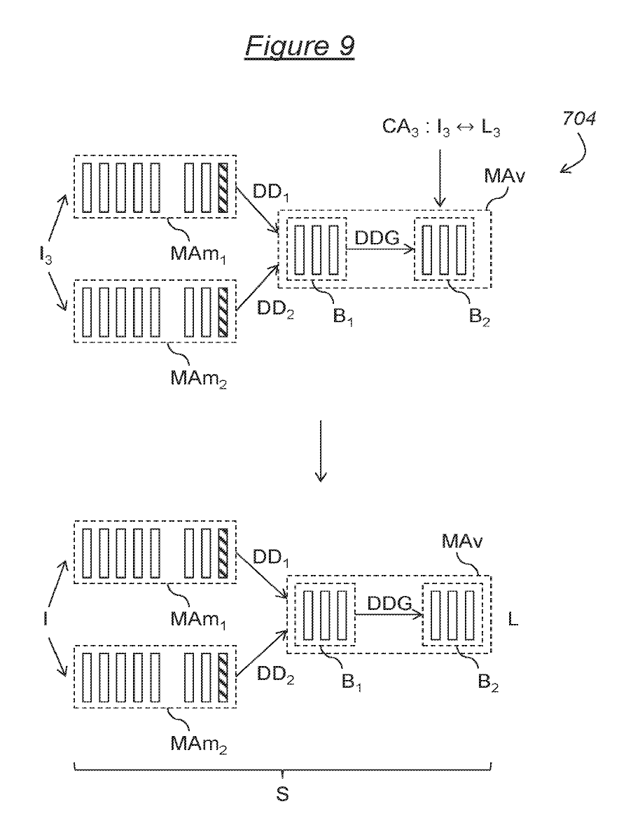

FIGS. 8 and 9 schematically show the operations carried out during steps of the method of FIG. 7,

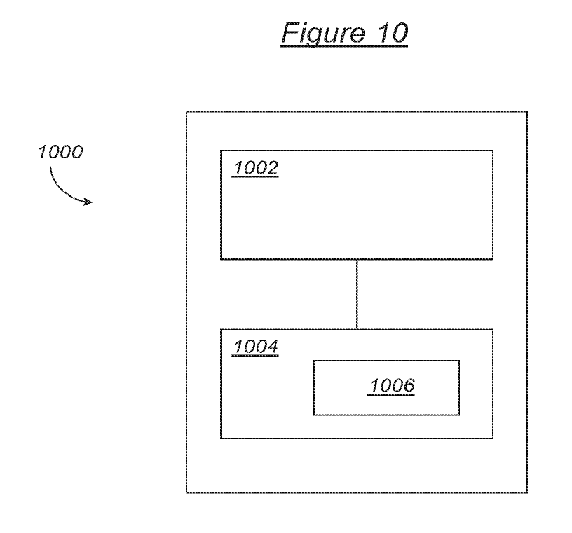

FIG. 10 schematically shows a device for obtaining a system for labelling images.

In the following description, the labelling of an image comprises the association of a score of this image with each of a plurality of predetermined labels.

Moreover, in the following description, a module can be either a physical module, that is to say a module microprogrammed or microwired in dedicated integrated circuits without intercession of a computer program, or a software module intended to be executed by a processing unit of a computer. Alternatively, a module can comprise certain physical portions and other software portions.

In reference to FIGS. 1 to 7, a first method 100 for designing a system S for labelling images will now be described.

During a step 102 (illustrated in FIG. 2), a first module for labelling images M₁ is obtained.

For this, the first module M₁ is trained by machine learning on a computer on the basis of a first training corpus CA₁ comprising first images I₁ associated with first labels L₁.

During the learning, the first module M₁ is parametered in such a way that, when it receives, as an input, one of the first images I₁, it provides, as an output, a labelling consistent with the first label L₁ associated with this first image I₁ in the first training corpus CA₁.

In the example described, the first module M₁ comprises successive processing layers starting with a first processing layer. The first processing layer is intended to receive the image to be labelled. The output of each processing layer is provided at the input of the following processing layer, except for the last processing layer which provides a labelling of the image to be labelled. Each processing layer comprises parameters that are adjusted during the learning.

Moreover, in the example described, the first module M₁ is a convolutional neural network. Thus, the first processing layers are convolutional layers CT₁ (five in the example described) and the following layers are completely connected neural layers CT₂ (three in the example described).

The first training corpus CA₁ is for example the image database ILSVRC (ImageNet Large Scale Visual Recognition Challenge) which is itself extracted from the image database ImageNet, labelled according to the WordNet hierarchy.

The labels used in the most common image databases, for example including ILSVRC, are generally very specific. Therefore, the images are very visually coherent and probably facilitate the machine learning. However, their use leads to obtaining a highly specialised first module M₁, which makes its reuse for labelling on the basis of other labels very difficult.

This is why a second more generic module for labelling images M₂ is obtained as will be described below, during the description of steps 104 and 106.

During an optional step 103, the first module M₁ is again trained, but partially this time, by machine learning on a computer on the basis of a third training corpus CA₃ comprising third images I₃ associated with third labels L₃. The machine learning is then carried out according to the method of “fine tuning” by adjusting only a portion of the parameters of the first module M₁. For example, only the parameters of one or more last neural layers CT₂ are adjusted. For example, only the parameters of the last neural layer are adjusted. The parameters of the other layers remain at their values resulting from the first machine learning of the first module M₁ on the basis of the first training corpus CA₁.

During a step 104, a second training corpus CA₂ is obtained on the basis of the first training corpus CA₁. The second training corpus CA₂ comprises the first images I₁ associated with second labels L₂.

Obtaining the second training corpus CA₂ comprises the replacement, in the first training corpus CA₁, of each of at least a portion of the first labels L₁ by a replacement label, at least two first labels L₁ being replaced by the same replacement label. The second labels L₂ comprise the replacement labels and the possible first labels L₁ that have not been replaced. Thus, all the first images I₁ that were associated, in the first training corpus CA₁, with the same first label L₁ that has been replaced are associated, in the second training corpus CA₂, with the replacement label of this first label L₁. Moreover, since at least two first labels L₁ are replaced by the same replacement label, the number of second labels L₂ is less than the number of first labels L₁. Thus, the replacement labels are labels having a more generic meaning than the first labels L₁ that they replace. For example, a replacement label for the first labels “Labrador” and “German shepherd” could be the label “dog” or the label “animal”. Thus, the second labels L₂ are more generic than the first labels L₁.

For example, obtaining the second training corpus CA₂ comprises, for each of at least a portion of the first labels L₁, the determination, in a predefined tree of labels including in particular the first labels L₁, of an ancestor common to this first label L₁ and to at least one other first label L₁, the common ancestor determined forming the replacement label of this first label L₁.

For example, the second training corpus CA₂ is obtained using the following algorithm.
a first set K1 of labels is initialised to contain the first labels L₁, and a second set K2 is initialised with an empty set,
repeat:
   for each label ci of the first set K1:
      for each label cj of the first set K1 different than the label ci:
         determine the closest common ancestor or “Lowest Common Ancestor” in the tree between the label ci and the label cj,
         propose to a user to replace ci by the closest common ancestor. If the user accepts the replacement, add the closest common ancestor to the second set K2, associate it with the first images associated with the label ci and exit the loop on the cj,
      if the label ci has not been replaced, add the label ci to the second set K2 while keeping its associations with the first images,
   reduce the second set K2 to unique labels by grouping together the first associated images I₁ if necessary,
   if the second set K2 is identical to the first set K1, exit the “repeat” loop. Otherwise, initialise the first set K1 with the labels of the second set K2 and initialise the second set with an empty set.

Again for example, the second training corpus CA₂ is obtained automatically on the basis of the first training corpus CA₁ and the tree, without the intercession of a user. For example, in the above algorithm, the step of acceptation or not of a replacement by the user is replaced by a step during which the closest common ancestor is automatically added to the second set K2 on the basis of one or more predefined criteria. For example, the predefined criterion or criteria comprise the criterion according to which the closest common ancestor belongs to a predetermined list of labels of the tree and the label ci does not belong to it.

Again for example, each of at least a portion of the first labels L₁ is replaced by the closest common ancestor of this first label L₁ and of at least one other first label L₁, this closest common ancestor being located above a predetermined level in the tree, the levels of the tree being increasing from the leaf labels to the root label. For example, in order to obtain this result, the predefined criterion or criteria for the above algorithm comprise the criterion according to which the closest common ancestor is above a predefined level in the tree and the label ci is below this predefined level.

Again for example, for each first label L₁, a user is proposed all the ancestors of this first label L₁ in the tree in order to select the replacement label of this first label L₁.

Thus, obtaining the second training corpus CA₂ requires very little manual work and can be automated completely or in part. Moreover, obtaining new labelled images is not necessary. Thus, the tedious work of labelling new images is avoided.

During a step 106 (illustrated in FIG. 3), the second module for labelling images M₂ is obtained.

For this, the second module M₂ is trained by machine learning on a computer on the basis of the second training corpus CA₂.

During the learning, the second module M₂ is parametered in such a way that, when it receives, as an input, one of the first images I₁, it provides, as an output, a labelling consistent with the second label L₂ associated with this first image I₁ in the second training corpus CA₂.

Preferably, the second module M₂ is also a convolutional neural network. Thus, the first processing layers CT₁ are convolutional layers (five in the example described) and the following layers are completely connected neural layers CT₂ (three in the example described).

Again preferably, the second module M₂ is obtained independently of the learning of the first module M₁ carried out in step 102. In other words, the first module M₁ obtained after step 102 is not used to obtain the second module M2.

During an optional step 107, the second module M₂ is again trained, but partly this time, by machine learning on a computer on the basis of the third training corpus CA₃. The machine learning is thus carried out according to the method of “fine tuning” by adjusting only a portion of the parameters of the second module M₂. For example, only the parameters of one or more last neural layers CT₂ are adjusted. For example, only the parameters of the last neural layer are adjusted. The parameters of the other layers remain at their values resulting from the first machine learning of the second module M₂ on the basis of the second training corpus CA₂.

During a step 108, the system S is obtained, in such a way that it comprises three modules MAm₁, MAm₂ and MAv. These three modules comprise, on the one hand, a first upstream module MAm₁ and a second upstream module MAm₂ designed to each receive the same image to be labelled I and to respectively provide first descriptive data DD₁ and second descriptive data DD₂ of the image to be labelled I and, on the other hand, a downstream module MAv designed to receive the first descriptive data DD₁ and the second descriptive data DD₂ and to provide a labelling L of the image to be labelled I.

The system S is for example obtained in the form of a computer program comprising instructions implementing the functions of the modules described above, when said computer program is executed on a computer. This computer program could also be divided according to all the possible combinations into one or more subprograms. The functions carried out could also be at least partly microprogrammed or microwired into dedicated integrated circuits. Thus, alternatively, the system S could be an electronic device composed only of digital circuits (without a computer program) for carrying out the same functions.

The step 108 of obtaining the system S comprises for example the following steps 110 to 114.

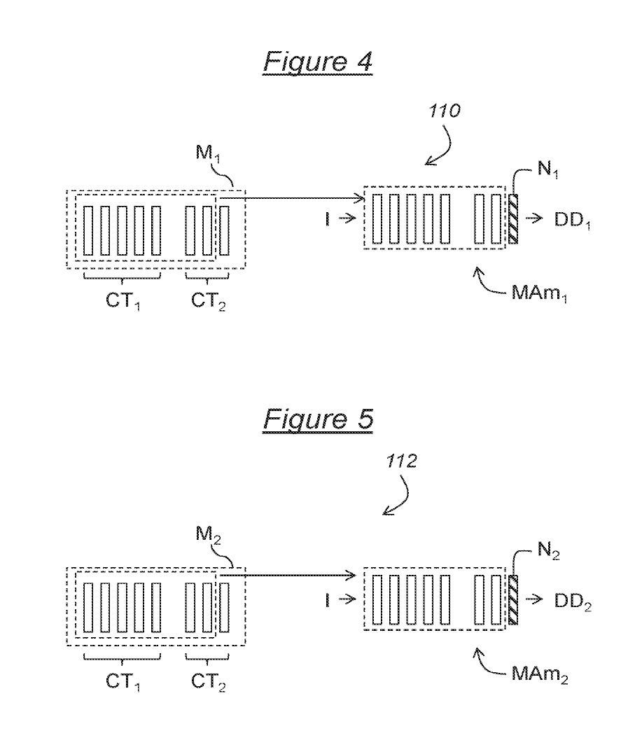

During a step 110 (illustrated in FIG. 4), the first upstream module MAm₁ is obtained from at least a portion of the first module M₁.

For example, the first upstream module MAm₁ comprises one or more successive processing layers CT₁, CT₂ of the first module M₁, preferably including the first processing layer.

In the example described, the first upstream module MAm₁ comprises the convolutional layers CT₁ and only a portion of the neural layers CT₂, for example all the neural layers CT₂ except for the last one.

Moreover, in the example described, the first upstream module MAm₁ comprises a normalisation layer N₁ placed after the last layer imported from the first module M₁. The normalisation layer N₁ is designed to normalise the output of the last layer imported from the first module M₁ according to a predefined vector norm, for example according to the Euclidean norm. Thus, in the example described, the normalised output of the last layer imported from the first module M₁ forms the first descriptive data DD₁.

During a step 112 (illustrated in FIG. 5), the second upstream module MAm₂ is obtained on the basis of at least a portion of the second module M₂.

For example, the second upstream module MAm₂ comprises one or more successive processing layers CT₁, CT₂ of the second module M₂, preferably including the first processing layer.

In the example described, the second upstream module MAm₂ comprises the convolutional layers CT₁ and only a portion of the neural layers CT₂, for example all the neural layers CT₂ except the last one.

Moreover, in the example described, the second upstream module MAm₂ comprises a normalisation layer N₂ placed after the last layer imported from the second module M₂. The normalisation layer N₂ is designed to normalise the output of the last layer imported from the second module M₂ according to a predefined vector norm, for example according to the Euclidean norm. Thus, in the example described, the normalised output of the last layer imported from the second module M₂ forms the second descriptive data DD₂.

Thus, the first descriptive data DD₁ is completed by the second descriptive data DD₂ which allows to describe the image at a more generic level than the first descriptive data DD₁ alone. This allows, as will be described below, efficient reuse of the machine learning carried out on the basis of the first training corpus CA₁ in order to label images according to new labels.

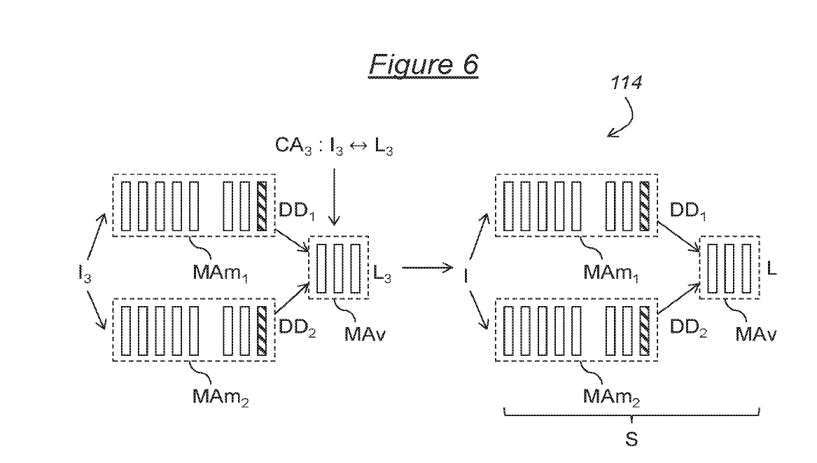

During a step 114 (illustrated in FIG. 6), the downstream module MAv is obtained.

In the example described, the downstream module MAv is trained by machine learning on a computer on the basis of the third training corpus CA₃.

During the learning, the downstream module MAv is parametered in such a way that, when the first upstream module MAm₁ and the second upstream module MAm₂ receive, as an input, one of the third images I₃, the downstream module MAv provides, as an output, a labelling consistent with the third label L₃ associated with this third image I₃ in the third training corpus CA₃. During the learning, the first upstream module MAm₁ and the second upstream module MAm₂ remain unchanged.

In the example described, the downstream module MAv comprises a neural network, for example comprising three layers of neurons.

The number of third images I₃ can be much less than the number of first images I₁. For example, the number of third images I₃ can be less than or equal to 10% of the number of first images I₁. Moreover, the third images I₃ can represent things completely different than the first images I₁, and the third labels L₃ can be different than the first labels L₁ and the second labels L₂. However, thanks to the presence of the second descriptive data DD₂, it was found that the system for labelling images S thus obtained gave good results for labelling images according to the third labels L₃, in any case results often better than when using the first descriptive data DD₁ alone.

In reference to FIGS. 7 to 9, a second method 700 for obtaining a program for labelling images P will now be described.

The method 700 is identical to the method 100 except for the differences that will now be described.

In the example described, the downstream module MAv comprises, on the one hand, a first block B₁ designed to receive, as an input, the first descriptive data DD₁ and the second descriptive data DD₂ and to provide, as an output, global descriptive data DDG combining in the example described the first descriptive data DD₁ and the second descriptive data DD₂ and, on the other hand, a second block B₂ designed to receive, as an input, the global descriptive data DDG and to provide, as an output, a labelling on the basis of this global descriptive data DDG.

Moreover, in the example described, the step 114 of obtaining the downstream module MAv comprises the following steps 702 and 704.

During a step 702 (illustrated in FIG. 8), the first block B₁ is trained by machine learning on a computer on the basis of a fourth training corpus CA₄ comprising the first images I₁ associated with pairs of labels L₁, L₂. The pair of labels L₁, L₂ of each first image I₁ comprises the first label L₁ associated with the first image I₁ in the first training corpus CA₁ and the second label L₂ associated with the first image I₁ in the second training corpus CA₂.

During the learning, the first block B₁ is parametered in such a way that, when the first upstream module MAm₁ and the second upstream module MAm₂ receive, as an input, one of the first images I₁, the first block B₁ provides, as an output, a double labelling (corresponding in the example described to the global descriptive data DDG) consistent with the pair of labels L₁, L₂ associated with this first image I₁ in the fourth training corpus CA₄. During the learning, the first upstream module MAm₁ and the second upstream module MAm₂ remaining unchanged.

In the example described, the first block B₁ is a neural network, for example comprising three layers of neurons.

During a step 704 (illustrated in FIG. 9), the second block B₂ is trained by machine learning on a computer on the basis of the third training corpus CA₃.

During the learning, the second block B₂ is parametered in such a way that, when the first upstream module MAm₁ and the second upstream module MAm₂ receive, as an input, one of the third images I₃, the second block B₂ provides, as an output, a labelling consistent with the third label L₃ associated with this third image I₃ in the third training corpus CA₃. During the learning, the first upstream module MAm₁, the second upstream module MAm₂ and the first block B₁ remain unchanged.

In the example described, the second block B₂ is a neural network, for example comprising three layers of neurons.

In reference to FIG. 10, a device 1000 for obtaining a system for labelling images S will now be described.

The device 1000 comprises for example a computer comprising a processing unit 1002 (comprising for example one or more processors) and a memory 1004 (comprising for example a RAM memory) for the storage of data files and of computer programs. The memory 1004 comprises in particular a program 1006 comprising instructions for carrying out a portion or all of the steps of a method for obtaining a system for labelling images S as described above, when said program 1006 is executed on the computer by the processing unit 1002.

The program 1006 could also be divided according to all the possible combinations into one or more subprograms. The steps carried out could also be at least partly microprogrammed or microwired into dedicated integrated circuits. Thus, alternatively, the computer implementing the processing unit 1002 could be replaced by an electronic device composed only of digital circuits (without a computer program) for carrying out the same steps.

It is clear that the methods described above make it possible to obtain a system for labelling images using at least a portion of a first module for labelling images trained on the basis of “specific” labels, and at least a portion of a second module for labelling images trained on the basis of “generic” labels, which allows to obtain good labelling performance.

Moreover, it is noted that the invention is not limited to the embodiments described above. Indeed, it is clear to a person skilled in the art that various modifications can be made to the embodiments described above, in light of the teaching that has just been disclosed to the person skilled in the art. In the following claims, the terms used must not be interpreted as limiting the claims to the embodiments disclosed in the present description, but must be interpreted to include all the equivalents that the claims aim to cover by their wording and the providing of which is within the reach of a person skilled in the art by applying their general knowledge to the implementation of the teaching that has just been disclosed thereto.

1: A method for obtaining a system for labelling images, comprising:
obtaining a first module for labelling images that has been trained by machine learning on a computer on the basis of a first training corpus comprising first images associated with first labels, in such a way that, when the first module receives, as an input, one of the first images, the first module provides an output consistent with the first label associated with this first image in the first training corpus,
obtaining the system for labelling images in such a way that it comprises:
a first upstream module designed to receive an image to be labelled and to provide first descriptive data of the image to be labelled, the first upstream module being obtained from at least a portion of the first module,
a downstream module designed to provide a labelling of the image to be labelled on the basis of the first descriptive data,
obtaining a second training corpus comprising the first images associated with second labels by replacing, in the first training corpus, each of at least a portion of the first labels by a replacement label, at least two first labels being replaced by the same replacement label, the second labels comprising the replacement labels and the possible first labels that have not been replaced,
the machine learning, on a computer, of a second module for labelling images on the basis of the second training corpus, in such a way that, when the second module receives, as an input, one of the first images, the second module provides an output consistent with the second label associated with this first image in the second training corpus,
the system for labelling images further comprising a second upstream module designed to receive the image to be labelled and to provide second descriptive data of the image to be labelled, the second upstream module being obtained on the basis of at least a portion of the second module,
and the downstream module being designed to provide a labelling of the image to be labelled on the basis of the first descriptive data and the second descriptive data,
wherein the method further comprises:
the machine learning, on a computer, of at least a portion of the downstream module on the basis of a third training corpus comprising third images associated with third labels, in such a way that, when the first upstream module and the second upstream module receive, as an input, one of the third images, the downstream module provides an output consistent with the third label associated with this third image in the third training corpus, the first upstream module and the second upstream module remaining unchanged during the learning.

2: The method according to claim 1, wherein each of the first module and the second module comprises successive processing layers starting with a first processing layer, wherein the first upstream module comprises one or more successive processing layers of the first module and wherein the second upstream module comprises one or more successive processing layers of the second module.

3: The method according to claim 2, wherein the processing layer(s) of the first upstream module comprise the first processing layer of the first module and wherein the processing layer(s) of the second upstream module comprise the first processing layer of the second module.

4: The method according to claim 2, wherein each of the first module and the second module comprises a convolutional neural network comprising, as successive processing layers, convolutional layers and neural layers that follow the convolutional layers.

5: The method according to claim 4, wherein the first upstream module comprises the convolutional layers and only a portion of the neural layers of the first module and wherein the second upstream module comprises the convolutional layers and only a portion of the neural layers of the second module.

6: The method according to claim 1, wherein obtaining the second training corpus comprises, for each of at least a portion of the first labels, the determination, in a predefined tree of labels including in particular the first labels, of an ancestor common to this first label and to at least another first label, the common ancestor determined being the replacement label of this first label.

7: The method according to claim 1, wherein the downstream module comprises, on the one hand, a first block designed to receive, as an input, the first descriptive data and the second descriptive data and to provide, as an output, global descriptive data and, on the other hand, a second block designed to receive, as an input, the global descriptive data and to provide, as an output, a labelling and further comprising:
the machine learning, on a computer, of the first block on the basis of a fourth training corpus comprising the first images associated with pairs of labels, the pair of labels associated with each first image comprising the first label associated with the first image in the first training corpus and the second label associated with the first image in the second training corpus, in such a way that, when the first upstream module and the second upstream module receive, as an input, one of the first images, the first block provides an output consistent with the pair of labels associated with this first image in the fourth training corpus, the first upstream module and the second upstream module remaining unchanged during the learning,
after the machine learning of the first block, the machine learning, on a computer, of the second block on the basis of the third training corpus, in such a way that, when the first upstream stage and the second upstream stage receive, as an input, one of the third images, the downstream module provides an output consistent with the third label associated with this third image in the third training corpus, the first upstream module, the second upstream module and the first block remaining unchanged during the learning.

8: A computer program that can be downloaded from a communication network and/or is recorded on a medium readable by computer and/or can be executed by a processor, characterised in that it comprises instructions for the execution of the steps of a method according to claim 1, when said program is executed on a computer.

9: A device for obtaining a system for labelling images, designed to implement a method according to claim 1.

10: A system for labelling images obtained by a method according to claim 1.
